(19) United States
(12) Patent Application Publication
(10) Pub. No.: US 2005/0144249 A1
(43) Pub. Date: Jun. 30, 2005

(54) Method to populate a database

(75) Inventors: Tony Alex, Huntington Station, NY (US); Thomas Strand, Glen Cove, NY (US); Peter J. Degen, Huntington, NY (US)

Correspondence Address: LEYDIG VOIT & MAYER, LTD, 6815 WEAVER ROAD, SUITE 300, ROCKFORD, IL, 61114-8018, US

(73) Assignee: US eDirect, Inc., Woodbury, NY (US)

(21) Appl. No.: 11/025,031

(22) Filed: Dec. 29, 2004

Related U.S. Application Data
(60) Provisional application No. 60/533,735, filed on Dec. 31, 2003.

(51) Int. Cl. G06F 15/167; H04M 3/42

(52) U.S. Cl. 709/212; 379/218.01

(57) ABSTRACT

The invention provides a system that provides a low-cost solution to populate a database with customer information. The system consists primarily of a Caller ID device connected to an incoming phone line prior to a business's phone device and to a computing device via a corn port, USB port, LAN, and the like. The computing device accesses websites on the Internet through an Internet connection (e.g., modem, cable, etc.). The system searches for hits on a predetermined list of “websites.” If a hit is registered, the system “screen scrapes” the results of that web page, parses the results for address information (e.g., first name, last name, street address, city, state and zip) and stores this information in a database on the local computer. The database update is typically conducted in real time.

### CROSS-REFERENCE TO RELATED PATENT APPLICATIONS

This patent application claims the benefit of U.S. Provisional Patent Application No. 60/533,735, filed Dec. 31, 2003.

### FIELD OF THE INVENTION

This invention pertains to databases, and more specifically, pertains to populating a database.

### BACKGROUND OF THE INVENTION

Customer lists are the backbone of many businesses as these contain contact information of customers interested in a business's products and/or services. As a result, an industry has sprung up to help businesses track their customers. Many of the members in the industry use proprietary databases that contain information about potential customers. Businesses using the proprietary databases pay a subscription fee, often monthly, to use the databases.

However, the cost of using the databases is prohibitive for small businesses and business start-ups. For example, the present day costs can run between $0.10-$0.25 for a single lookup in such a database. For a business that receives between 300-1500 calls a day, the use of the database can result in costs of between $900 to $11,000 a month, just for the purpose of publicly available data lookup. Another economic reality is during a business startup, there is often little or no guiding experience that exists in creating customer lists. In these instances, it is likely that a user who requires collecting information from all over the country or the world would require access to a tremendously large database. Such a database is not something a startup business can create on its own and hence the business would be forced to subscribe to several commercial databases to get adequate coverage. This is cost prohibitive for most businesses. The expense drove some members of the industry to create other methodologies to assist businesses with customers.

For example, one methodology industry created captures the name and number from the Caller ID service. Another methodology generates customer addresses and mailing labels from caller data. This methodology is a monthly subscription service that captures the caller information and transmits the data to a central location where computers analyze the caller information and match phone numbers with a caller's name and address, checks the address with the US Postal Service database, and provides latitude and longitude of the address. However, both of these systems are costly for small businesses and still use proprietary databases.

### BRIEF SUMMARY OF THE INVENTION

The invention provides a system that provides a low-cost solution to populate a database with customer information. The system consists primarily of a Caller ID device connected to an incoming phone line prior to a business's phone device. The Caller ID device is connected to a computing device via a COM port, USB port, LAN, etc. The computing device accesses websites on the Internet through an Internet connection (e.g., modem, cable, wireless, etc.).

The computing device searches for hits on a predetermined list of “websites.” If a hit is registered, the system “screen scrapes” the results of that web page, parses the results for address information (e.g., first name, last name, street address, city, state and zip) and stores this information in a database on the local computer. Screen scraping is the act of programmatically evaluating the information displayed on a screen (i.e., the web page) and extracting from it the specific information one needs. The database update is typically conducted in real time.

The system uses publicly available information that is available on numerous websites and is typically free as opposed to databases such as a LIDB (line information database) that have a cost associated with each lookup. Such website information is typically updated constantly on the Internet. As a result, the system does not require the user to maintain or pay for an external database and the data is always as current as the website information.

Other aspects, objectives and advantages of the invention will become more apparent from the following detailed description when taken in conjunction with the accompanying drawings.

### BRIEF DESCRIPTION OF THE DRAWINGS

FIG. 1 is a block diagram generally illustrating an exemplary environment in which the present invention operates; and

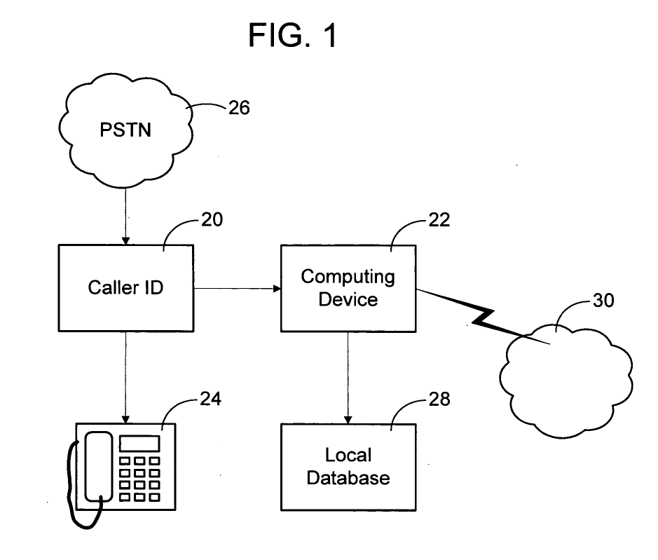

FIG. 2 is a flow chart illustrating the steps the present invention performs.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The invention allows a user to populate a database with customer information from customers who call the user using publicly available information. Turning to the drawings, wherein like reference numerals refer to like elements, the invention is illustrated as being implemented in a suitable environment. A caller id device 20 is in communication with computing device 22 and phone 24 that receives calls from the public switched telephone network (PSTN) 26. While caller id device 20 is shown as being separate from phone 24 for clarity, the caller id device 20 may be integral with phone 24. Computing device 22 may be a desktop computer, a laptop, a PDA, and the like. The link between the computing device 22 and the caller id device 20 may be a wireless link through a wireless port of the computing device 22 such as an infrared port or the link 24 may be a “wired” port such as a USB port or a serial port. The computing device 22 is in communication with database 28 to store information about the caller that is retrieved from the Internet 30 as described herein below.

Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, cellphones, mainframe computers, distributed computing environments that include any of the above systems or devices, and the like.

In its most basic configuration, the computing device 22 includes at least a processing unit and a memory. Depending on the exact configuration and type of computing device, the memory may be volatile (such as RAM), non-volatile (such as ROM, flash memory, etc.) or some combination of the two. Additionally, the device 22 may also have additional features/functionality. For example, the device 22 may also include additional storage (removable and/or non-removable) including, but not limited to, magnetic or optical disks or tapes. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 22. Any such computer storage media may be part of the device 22.

The device 22 may also contain one or more communications connections that allow the device to communicate with other devices. The communications connections are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As discussed above, the term computer readable media as used herein includes both storage media and communication media.

The device 22 may also have one or more input devices such as keyboard, mouse, pen, voice input device, touch-input device, etc. One or more output devices such as a display, speakers, printer, etc. may also be included. All these devices are well known in the art and need not be discussed at greater length here.

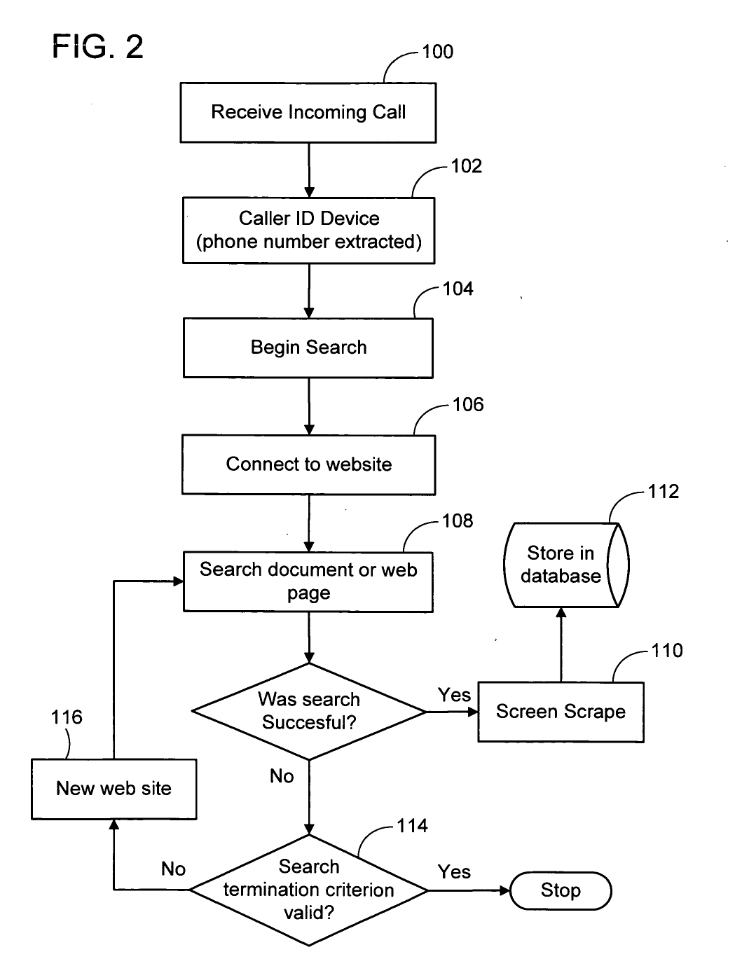

Turning now to FIG. 2, the operation of the system shall now be described. When an incoming call is detected by the caller Id device 20 (step 100), it extracts Caller Id information (e.g., the phone number) and transfers the information to the computing device 22 (step 102). If the phone system is a digital system instead of the PSTN 26, a caller ID device 20 may not be needed as the phone call contains session ANI (Automatic Number Identification) data that includes the Caller ID information, which can be electronically extracted from the ANI data. The computing device 22 begins the search by connecting to websites for hits on a predetermined list of “websites” residing on Internet 30. The list of websites may include search engines such as google.com, anywho.com, askjeeves.com, AltaVista, yellowpages.com, metacrawler.com, whitepages.com and the like. The system connects to a website (step 106) and searches in documents or web pages for a hit (step 108). If a hit is registered, the system “screen scrapes” the information of interest from that web page or document and parses the results of the screen scraping for address information (e.g., first name, last name, street address, city, state and zip, etc.) (step 110). The information is stored in a database on the computing device 22 (step 112). The database update is typically conducted in real time. The database may be a relational database such as SQL, Access, Oracle, and the like, a text file, an excel spreadsheet or other electronic list.

Screen scraping, as used herein, refers to the process of programmatically evaluating information displayed on the screen (i.e., the document or web page) and extracting from it only the specific information that is needed. For example, web search engines can be considered screen scrapers. They look at the HTML of a page and record the keywords they find often by parsing the HTML with programs designed to mine out particular patterns of content.

If the search is not successful, the system checks to see if all websites have been searched and also decides if the search should be terminated (step 114). If the search is to be continued, the computing device 22 connects to another website (step 116) and repeats the process of steps 108-116 until the search is terminated or a hit is registered. Under certain circumstances it may be desirable to enter the telephone number manually into the process of this invention. In such cases the operator requests the caller's phone number and enters it manually and the system of this invention then takes over and produces the additional customer information by the previously described process. This allows the user to still have the benefits of automatic data retrieval even in those cases where the person whose information is to be collected makes an enquiry through a method other than using a telephone to call in or when the ANI information is not available.

An example of the above described method shall now be presented. In this example, a golf course reservation system was used. A computer at the Great Rock golf course is equipped with a product which detects, identifies, and data logs incoming caller information in accordance with the teachings of the present invention. The system contained a caller Id unit that was connected to the computer via a “com” cable and software components that included operator user interfaces and a database. An unpopulated internal database was used. Internal database, as used herein, means a data store that is used by the product to store information on callers after it has been acquired. Note that a populated database may also be used. The populated database may be pre-populated with information from an external database or from prior use of the internal database. As used herein, an external database is a source of information external to the system of the invention. The computer had further means to connect to the Internet via broadband access. Note that other methods to connect to the Internet can be used. For example, the connection could be a wireless connection, a cable modem connection, etc. One telephone line from the golf course was routed to the caller id unit and then back into a telephone handset.

A golfer who had never before made a reservation at the Great Rock golf course called the golf course to make a tee time reservation. The system checked to see if the golfer had called before based upon the phone number and/or other caller ID information. Before the first telephone ring sounded at the golf course, the course operator saw a screen pop up on the computer that presented the operator with information including, by way of example and not limitation, the caller's phone number, name, address, Zip code, and Geographic coordinates of address. Based on this information, the operator was able to book a reservation for this golfer without any additional key strokes besides selecting an open time for the reservation. The information was acquired using the method described herein and the internal database was populated with the acquired information. Additionally, in this embodiment, this data appeared in tabular form in the internal database and became a permanent part of the golf course's searchable internal database. All this information was obtained without cost by means of screen scraping information on the Internet. This invention therefore informs the operator of information such as, by way of example and not limitation, who the caller is, the caller's phone number, the address information associated with the phone number, the latitude and longitude of the call location, and the number of previous times the caller has called the golf course. Since this data is already collected the operator can transfer all this customer information to a reservation template with a single key stroke, rapidly and without error.

From the foregoing, it can be seen that users can automatically create a database of names and addresses of all incoming calls without user intervention. The system differs from conventional methods for several reasons. One reason is the use of the technique of screen scraping publicly available information from public websites; other techniques involve the association of caller id information by looking up existing databases. Public information is available on numerous websites and is typically free as opposed to databases such as LIDB (line information database) that have a cost associated with each lookup. Information is typically constantly updated on the web and does not require the user to maintain or pay for an external database. Additionally, the information needed may not be available in a search database while the web has multiple sources of information.

The invention can be used for many purposes. One use is in directory creation. A user can automatically create and update their electronic telephone directory with names, addresses and numbers. Another use is automatic directory creation for cell phone users. Another use is marketing response tracking. Marketing programs such as advertising often result in consumers responding to a call to action by making a phone call to the marketers. When the consumers call, the marketers can now automatically generate marketing efficiency reports by zip code or area code. Since the incoming call can be automatically assigned to an address, users can further assign geographical data (latitude and longitude) and pin point where their potential customers are calling, allowing them to measure effectiveness in real time and thus make changes to their marketing program in a timely fashion.

Another use is to automatically update addresses in a database. The method can further be used to update area code and exchange number changes for phone numbers in the database. Another use is to automatically update address information associated with every phone number from a list of phone numbers on a pre programmed schedule. For example, instructing the system to carry out daily updates and provides a database that is current within 24 hours of the information available on the World Wide Web. Another use is customer registration over an automated phone system (e.g., an Interactive Voice Response (IVR) system). Some businesses allow access to their programs via an IVR (Interactive Voice Response) phone system. These organizations have a need to collect names and addresses of people using their programs. Currently, these automated systems require a customer to switch to a live operator to input the customer's information because it is almost impossible for a caller to input name and address information via a telephone keypad into an automated phone system. Such a mode of data entry is extremely tedious and prone to error. Using the invention, such organizations will be able to register customers over an automated phone system with a high degree of accuracy and without the need to switch to a live operator.

Another use is verification. Various “businesses” ask for phone and address information prior to a consumer being able to use their facilities. One such example is a hotel or a motel where the consumer is always asked their home address. Using this system the “business” can speed up the input process by independently verifying if the address being taken is a real one. Yet another use is marketing to customers who call. Many businesses have a situation where a customer will call and may not be ready to buy at that time. This invention will allow the business to automatically generate mailing labels to send information to these potential customers.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. At least one computer-readable medium for acquiring address information, the at least one computer-readable medium having computer-readable instructions for performing the steps comprising:
detecting a phone call;
extracting identifier information from the phone call;
searching for address information on at least one website using the identifier information, the website having at least one of a webpage or a document;
if a hit is registered, parsing the at least one of the webpage or the document for the address information; and
storing the address information in a database.

2. The at least one computer-readable medium of claim 1 wherein the step of parsing the at least one of the webpage or the document for the address information includes the step of screen-scraping the at least one of the webpage or the document.

3. The at least one computer-readable medium of claim 1 wherein the step of extracting identifier information from the phone call comprises the step of extracting identifier information from session automatic number identification data.

4. The at least one computer-readable medium of claim 1 wherein the at least one website resides on the Internet, the computer-readable medium having further computer-executable instructions for performing the step comprising connecting to the Internet.

5. The at least one computer-readable medium of claim 1 having further computer-executable instructions for performing the step comprising searching for the address information in the database and wherein the step of searching for the address information on the at least one website comprises the step of searching for the address information on the at least one website if the address information is not in the database.

6. The at least one computer-readable medium of claim 1 wherein the step of searching for address information on at least one website comprises the step of searching for address information on a predetermined list of websites.

7. The at least one computer-readable medium of claim 6 wherein the step of searching for address information on a predetermined list of websites includes the step of searching for address information until a hit is registered.

8. The at least one computer-readable medium of claim 6 wherein the step of searching for address information on a predetermined list of websites includes the steps of:
determining if all websites in the predetermined list of websites has been searched; and
determining if the step of searching should be terminated.

9. The at least one computer-readable medium of claim 1 wherein the step of parsing the at least one of the webpage or the document for the address information includes the step of parsing the at least one of the webpage or the document for at least one of a first name, a last name, and an address.

10. The at least one computer-readable medium of claim 1 wherein the step of extracting identifier information from the phone call includes the step of asking the caller for the caller's phone number.

11. A method for acquiring address information comprising the steps of:
detecting a phone call;
extracting identifier information from the phone call;
searching for address information on at least one website using the identifier information, the website having at least one of a webpage or a document;
if a hit is registered, parsing the at least one of the webpage or the document for the address information; and
storing the address information in a database.

12. The method of claim 11 wherein the step of parsing the at least one of the webpage or the document for the address information includes the step of screen-scraping the at least one of the webpage or the document.

13. The method of claim 11 wherein the step of extracting identifier information from the phone call comprises the step of extracting identifier information from session automatic number identification data.

14. The method of claim 11 wherein the at least one website resides on the Internet, the method further comprising the step of connecting to the Internet.

15. The method of claim 11 further comprising the step of searching for the address information in the database and wherein the step of searching for the address information on the at least one website comprises the step of searching for the address information on the at least one website if the address information is not in the database.

16. The method of claim 11 wherein the step of searching for address information on at least one website comprises the step of searching for address information on a predetermined list of websites.

17. The method of claim 16 wherein the step of searching for address information on a predetermined list of websites includes the step of searching for address information until a hit is registered.

18. The method of claim 16 wherein the step of searching for address information on a predetermined list of websites includes the steps of:
determining if all websites in the predetermined list of websites has been searched; and
determining if the step of searching should be terminated.

19. The method of claim 11 wherein the step of parsing the at least one of the webpage or the document for the address information includes the step of parsing the at least one of the webpage or the document for at least one of a first name, a last name, and an address.

20. An apparatus for determining address information, the apparatus adapted to perform the steps comprising:
detecting a phone call;
extracting identifier information from the phone call;
searching for address information on at least one website using the identifier information, the website having at least one of a webpage or a document;
if a hit is registered, parsing the at least one of the webpage or the document for the address information; and
storing the address information in a database.

21. The apparatus of claim 20 wherein the apparatus is further adapted to perform the steps comprising:
determining if all websites in a predetermined list of websites has been searched; and
determining if the step of searching should be terminated.

22. The apparatus of claim 20 wherein the apparatus is integrated with a phone.
